(19) United States
(12) Patent Application Publication
(10) Pub. No.: US 2008/0086385 A1
(43) Pub. Date: Apr. 10, 2008

(54) DATA PROCESSING SYSTEM USING INDEPENDENT AND DEPENDENT ASSETS

(76) Inventor: AMANDA ELIZABETH CHESSELL, Alton (GB)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/780,806

(22) Filed: Jul. 20, 2007

(30) Foreign Application Priority Data
Oct. 4, 2006 (GB) 0619552.3

(51) Int. Cl. G06Q 10/00; G06Q 30/00

(52) U.S. Cl. 705/26

(57) ABSTRACT

A data processing system comprises an administration control point, a plurality of independent assets and dependent assets, and a plurality of administration resource models. Each independent asset includes an administration zone connected to the administration control point. Each administration resource model defines configuration data required by a respective asset. Each administration zone comprises a link to the administration resource model for that independent asset and each administration resource model for a dependent asset has a link present in an administration zone. The system also includes an administration dependency model defining the hierarchy of independent assets and dependent assets.

### FIELD AND BACKGROUND OF INVENTION

This invention relates to a data processing system and to a method of constructing a data processing system.

In many business environments, extremely complex computing systems are required. The data that is handled and processed by such systems is often large in quantity and requires fast and secure processing and storage/recall. Such data processing systems are frequently distributed across different software functions and across different computer hardware. In many cases parts of the system are located around the World. An example of this type of system would be an Internet based purchasing system, for example for a website selling goods to the public. In addition to maintaining the software displaying the website, the data processing system implementing the website must securely maintain client records and must manage transactions on the website, checking account balances and stock levels and ordering and sending goods, and so on. Since all of this must be done without undue delay and without allowing fraud, the creation of such a robust and complex system is a difficult task.

A solution is a collection of software applications and systems (such as databases etc.) that are targeted towards a particular business problem. One method for engineers to architect their solutions is to use a service oriented architecture. This splits the solution into a collection of inter-dependent services. Each service has a well-defined interface that other services can call. The implementation of the service may be changed without affecting other services, so long as the interface remains the same.

One of the problems with a service-oriented approach is how to control the configuration of the services within a solution. There are presently two approaches. Firstly a service owns and manages its own configuration data. An administrator uses an interface provided by the service to view and update the configuration data. This approach has the advantage that the service is a fully independent unit. When an implementation is changed (which typically changes the configuration data that is required) the administration can be changed without impacting other parts of the solution. One disadvantage of this approach is that there is no central definition of the complete configuration for the solution. The same item of data could be repeated in different services resulting in the possibility for inconsistent values being configured. In addition, the administrator is exposed to the structure of the services within the solution, and it is also likely that each service will have its own style of admin interface.

A second approach to the management of configuration data is to use a central definition of the configuration data that each service accesses as they require. This has the advantage that the configuration data is tightly controlled and managed as a coherent unit within the solution. The disadvantage is that when a service implementation is replaced, it is harder to co-ordinate the corresponding changes to the central configuration data store schema.

Typically, approach one is better for course-grained services and approach two is better for fine-grained or stable services. A solution is commonly made up of a mixture of course-grained and fine-grained services. Having a mixture of configuration approaches, in many cases, is confusing for the administrator.

### SUMMARY OF THE INVENTION

According to a first aspect of the present invention, there is provided a data processing system comprising an administration control point, a plurality of independent assets and dependent assets, each independent asset including an administration zone connected to the administration control point, and a plurality of administration resource models each defining configuration data required by a respective asset, wherein each administration zone comprises a link to the administration resource model for that independent asset and each administration resource model for a dependent asset has a link present in an administration zone.

According to a second aspect of the present invention, there is provided a method of constructing a data processing system comprising acquiring an administration control point and a plurality of independent assets and dependent assets, each independent asset including an administration zone connected to the administration control point, acquiring a plurality of administration resource models each defining configuration data required by a respective asset, and configuring the administration zones such that each comprises a link to the administration resource model for that independent asset and each administration resource model for a dependent asset has a link present in an administration zone.

According to a third aspect of the present invention, there is provided a computer program product on a computer readable medium for constructing a data processing system, the product comprising instructions for acquiring an administration control point and a plurality of independent assets and dependent assets, each independent asset including an administration zone connected to the administration control point, for acquiring a plurality of administration resource models each defining configuration data required by a respective asset, and for configuring the administration zones such that each comprises a link to the administration resource model for that independent asset and each administration resource model for a dependent asset has a link present in an administration zone.

This invention describes a method and system that combines both prior art approaches to take the advantages of both approaches and minimize their disadvantages. The invention provides a centralized admin control point where the solution's configuration data can be viewed and updated in a coherent manner whilst also allowing support for fine-grained services to rely on an external configuration manager to handle their configuration data, and support for course-grained services to manage the structure and content of their configuration data. The system also provides the ability for a service's implementation to be changed and its new configuration schema to be automatically/immediately reflected in the solution's centralized view. The invention also allows the sharing of configuration data between services that were designed/implemented independently.

This invention introduces the following concepts:

a number of resource models: each describing the structure of some related configuration data,

a definition for each service (independent or dependent asset) that describes which resource models they own and which resource models they are dependent on. A correctly defined solution has an owner for every resource model that is required by the solution's constituent services,

a definition of the hierarchy of services within the solution. This is called the dependency model. The dependency model also captures which services wish to manage their configuration data (called independent assets) and which services wish to have their configuration data managed externally (called dependent assets),

an administration zone service interface that is implemented by every independent asset (and the top-level solution, which can be considered to be an independent asset). This provides access to the resource models owned by the independent asset itself and any dependent assets nested within the independent assets, and

an administration control point service interface. This is used by the administrator's GUI or command script to view and change the solution's configuration data.

The hierarchy of services are split into zones, each zone is controlled by an independent asset (or the top-level solution). The independent asset (or the top-level solution) implements the administration zone service interface. They are responsible for the configuration data within their zone. The administration control point service is configured with a list of administration zone services. There is one administration zone service for each solution. The administration control point interface is used to locate the administration zone service for a particular solution.

Once the top-level administration zone service for the solution is located, its interface can be used to query and update all of the configuration data in the solution. The solution's top-level administration zone uses the dependency model to route requests to the correct administration zone nested within the solution.

Dependent assets can either access their configuration data directly through their local administration zone or through the top-level administration zone (or any one in between). The sequence of to the zone service interface calls is identical (although using the local administration zone service would be faster, especially in a large solution since the navigation between the zones is avoided).

### BRIEF DESCRIPTION OF DRAWINGS

Some of the purposes of the invention having been stated, others will appear as the description proceeds, when taken in connection with the accompanying drawings, in which:

FIG. 1 is a schematic diagram showing the relationship between a solution, computing assets and a middleware platform,

FIG. 2 is a schematic diagram of a data processing system,

FIG. 3 is a schematic diagram, similar to FIG. 1, showing an asset shared between two systems,

FIG. 4 is a schematic diagram of an administration architecture for use in the data processing system of FIG. 2,

FIG. 5 is a schematic diagram of an administration data model,

FIG. 6 is a diagram of a service interface to a control point,

FIG. 7 is a diagram of a service interface to an administration zone, and

FIG. 8 is a flow diagram of a method of constructing a data processing system.

### DETAILED DESCRIPTION OF INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

A solution (meaning an entire data processing system for carrying out a defined function such as running a website) is shown in FIG. 1, and is constructed from some solution specific code 10 and a number of assets 12 such as building blocks, solution components and functions. This solution runs on a platform of middleware 14. An asset 12 may also embed another asset 12 inside itself, creating a hierarchy of assets 12 inside each solution.

From an administrative point of view, an asset 12 can have one of the following configuration requirements, none, dependent or independent. If the requirement is none, then the asset 12 requires no configuration as all the data needed is passed on calls to its business service interface. If the asset 12 is categorized as dependent, then it requires an injection of configuration data each time that the asset 12 starts up (and whenever the configuration changes) since the asset 12 has no way to store and update the configuration data in a persistent manner. If the asset 12 is considered independent, then it maintains its own store of configuration data. The asset 12 also has a configuration interface so its configuration data can be updated without going through any other interface.

Both dependent and independent assets 12 require a definition of the configuration data they are using. This definition is called an administration resource model. This model defines the data fields within the configuration. Each asset 12 typically has at least one resource model. There are also resource models that describe shared configuration data. The structure of the resource models reflects the logical structure of the configuration data. Each asset 12 must declare which resource models it requires and which ones it owns. A coherent solution has an owner for each resource model required by its constituent assets.

The administration architecture of the overall solution divides responsibility for managing the configuration data between the solution and any independent asset 12a embedded within it. The top-level solution 10 is responsible for such things as solution-wide configuration (such as solution name, version etc), any configuration of its solution-specific code, and the configuration for each embedded dependent asset 12. Each independent asset 12 is responsible for its own configuration data and the configuration data for each of its embedded dependent asset 12b.

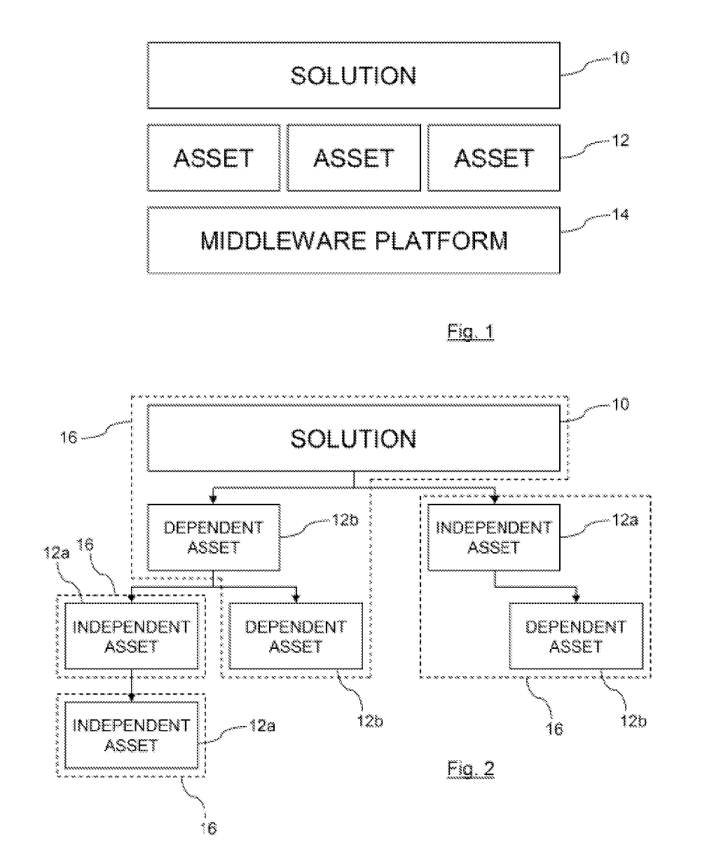

FIG. 2 shows a data processing system as an example solution with embedded assets 12. The dotted lines 16 show the partitioning of responsibility for configuration data within the overall system. The top-level solution specific code 10 and each independent asset 12a must support an administration zone interface. This interface allows the content of the configuration data to be queried and updated either by the administrator or by the dependent assets 12b within a specific administration zone. The administration zone is also responsible for delegating requests down to any subordinate administration zones as appropriate.

In general, an instance of an asset 12 is used exclusively by a single system. However, it is possible for an asset 12 to be a shared resource between two components (for example, a provenance server may be collecting data from two different systems). This can be seen in FIG. 3, which shows two systems with a shared asset 13. When this occurs there are three approaches. Firstly, if the shared asset 13 is independent, it could be administered as a solution, secondly, the asset 13 could be administered through just one of the solutions, or thirdly it could be administered through all of the solutions (as long as this does not upset the integrity of the asset's configuration).

The hierarchy of administration zones of responsibility within a solution is recorded in an administration dependency model. This model is used by the administration code within a particular administration zone to direct requests for configuration to the appropriate destination.

Solutions (and shared, independent assets 12a) are managed through an administrative control point. A control point is a single point of control for an administrator. Each system can be administered from its own single control point, or as part of a collection of solutions. The choice is made at solution deployment. All administration control points support a service interface so they can be incorporated in other administration tools such as the IBM Integrated System Console (ISC).

Two solution components support the administration architecture. Firstly, the administration control point, which provides all of the necessary support for a control point. This includes a portlet for logging onto the control point and navigating around the configuration. Secondly, an administration zone manager provides all of the necessary support for a solution 10 or independent asset 12a to manage the configuration data for itself and all dependent assets 12b. It uses the administration resource models for these assets 12 that have been linked together in an administration dependency model.

These solution components provide all the necessary support for the administration architecture. The only solutions/assets that would not use them are those that already have their own administration support. These assets 12 need to implement the administration zone interface to connect into the administration architecture.

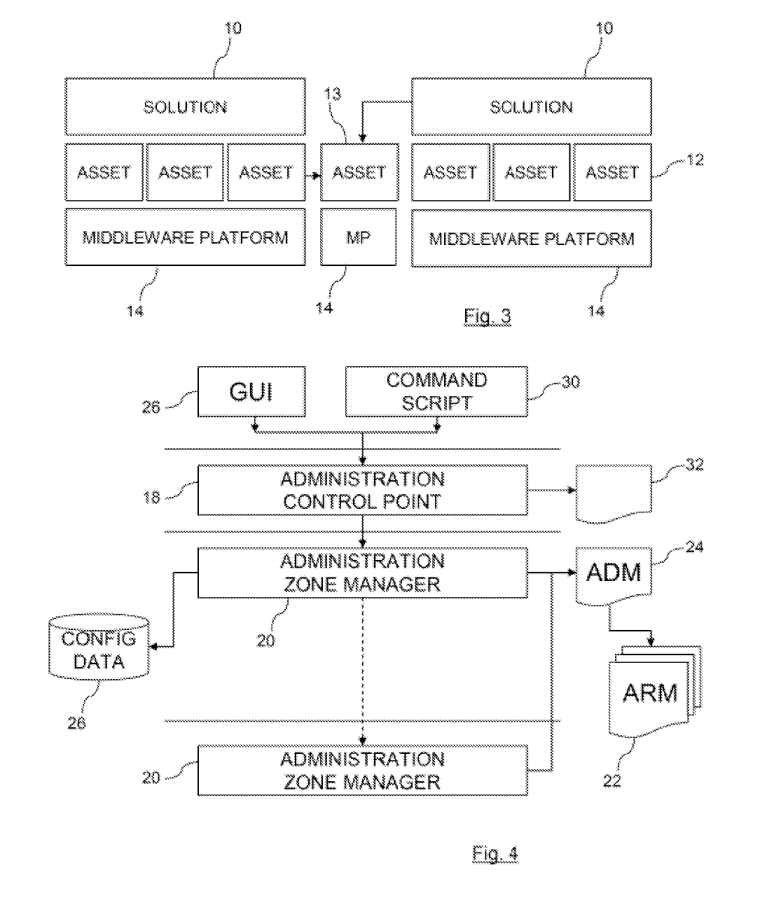

FIG. 4 shows in more detail the administration architecture for the data processing system, which divides the responsibility for managing configuration data within a system between the solution 10 and course-grained assets 12a that have independent administration capability.

The system includes the administration control point 18, along with the plurality of independent assets 12a and dependent assets 12b. Each independent asset 12a includes an administration zone 20 connected to the administration control point 18, either directly or indirectly. The system also has a plurality of administration resource models 22 each defining configuration data required by a respective asset 12. Each administration zone 20 comprises a link to the administration resource model 22 for that independent asset 12a and each administration resource model 22 for a dependent asset 12b has a link present in an administration zone 20.

The system further comprises the administration dependency model 24, which defines the hierarchy of the independent assets 12a and dependent assets 12b. At least one of the administration zones 20 has access to a database 26 storing configuration data. The administration control point 18 includes a service interface, and a graphical user interface 28 is connected to the service interface of the administration control point 18. The control point 18 is also connected to a command script 30 and a top-level administration managers list 32.

The management of configuration data from a single point of control is possible because of the administration dependency model 24 that arranges the solution 10 and its assets 12 into an administration hierarchy. The solution 10 and each independent asset 12a implement the same administration zone 20 with an interface enabling administration requests to be targeted to the correct administration manager in each administration zone 20.

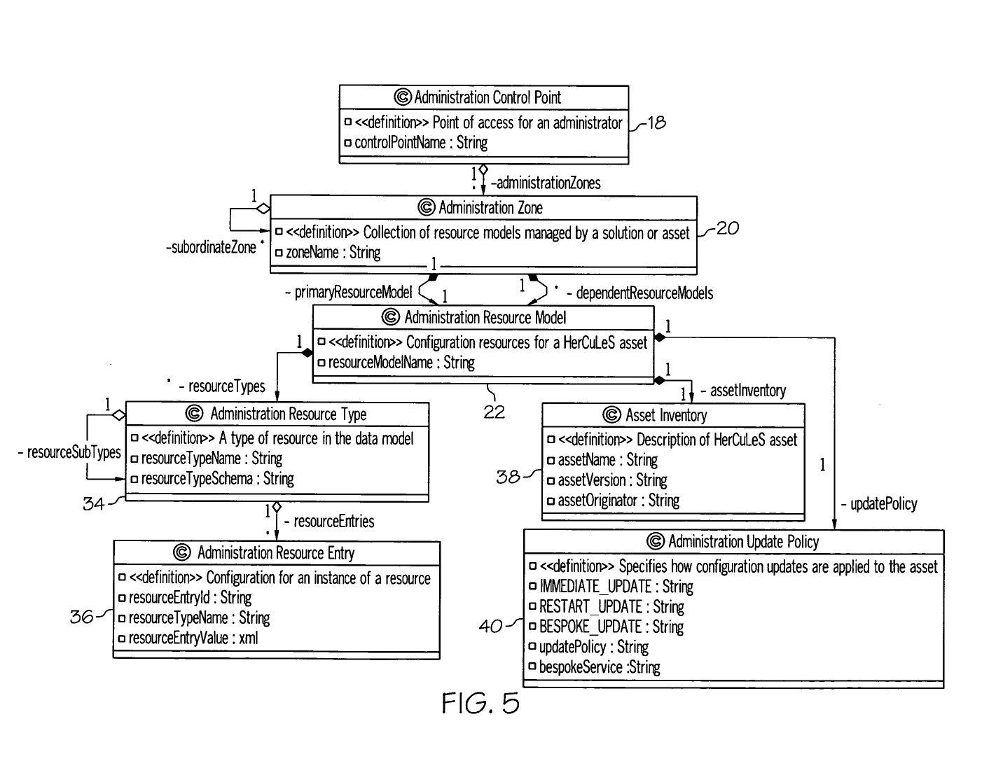

An example of an administration data model is shown in the UML diagram of FIG. 5. This illustrates the structure of the data that is distributed between the control point 18 and administration zones 20.

The administration control point 18 is the anchor of the administration data. It has a unique name (controlPointName) and a list of top-level administration zones 20 it is managing. An administration zone 20 represents either a solution 10 or an independent asset 12a. Each administration zone 20 has a unique name (zoneName) and three groups of links. These links are: primaryResourceModel, the link to the resource model for the solution/asset that is managing the zone, dependentResourceModels, the link to the resource models of dependent assets that are within the administration zone, and subordinateZones, the collection of administration zones 20 embedded in this zone 20.

The collection of administration zones 20 and their links make up the administration dependency model 24. The administration resource model 22 defines the configuration data for a solution 10 or asset 12. Each resource model 22 has a unique name (dataModelName) and contains the following information:
resourceTypes, the list of top-level resource types in the resource model 22, assetinventory, a description of the asset 12 that owns this datamodel, and updatePolicy, information on how the asset 12 processes new configuration data. A resource type 34 defines the name (resourceTypeName) and schema (resourceTypeSchema) of a resource that needs to be configured in a resource model 22. For example, a resource type could define the attributes configured in entries in a resource model 22 that describe a document type.

A resource entry 36 is an instance of a resource type 34. So if a resource type 34 defines the attributes for a document type description, then each description of a document type that is configured would be in its own resource entry 36. Each resource type has a name (resourceTypeName) and a schema defining the attributes that belong in the resource type (resourceTypeSchema).

An asset inventory 38 identifies the asset 12 that owns the resource model 22. This includes the asset's name (assetName), its version number, n.m (assetVersion) and its originator (assetOriginator). The administration update policy 40 describes how the asset processes new configuration data.

The updatepolicy field can have one of three values:

IMMEDIATE_UPDATE—changes to configuration take effect immediately,

RESTART_UPDATE—changes to configuration take place after a restart of the asset, and

BESPOKE_UPDATE—the asset has a bespoke interface for affecting administration changes in the asset.

If the updatepolicy is BESPOKE_UPDATE then the web service that provides this bespoke interface is defined in bespokeService.

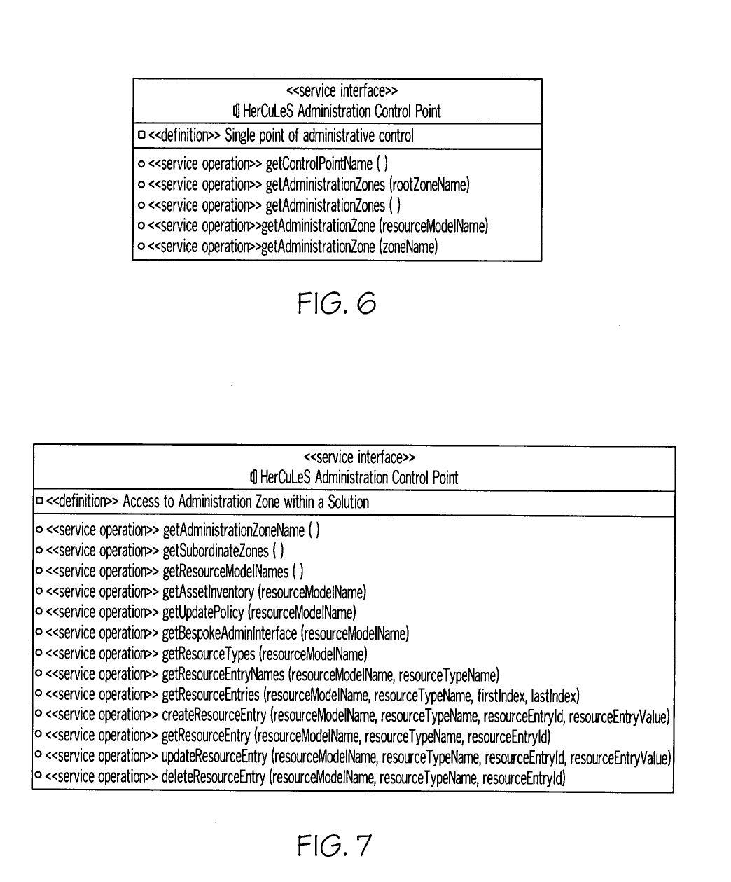

The control point interface gives an administration GUI the ability to access a control point. It has three service operations, and these are shown in FIG. 6. These three operations are:

getControlPointName( ) returns the name of the control point,

getAdministrationZones( ) returns the WSDLs for all administration zones that are subordinate to the rootZoneName zone. If the rootZoneName is not specified, the top-level administration zones are returned, and

getAdministrationZone( ) returns a specific zone. This can either be indexed by zone name or the resource model name.

The administration zone interface gives access to all of the administration resource models in the administration zone 20. It has the service operations shown in FIG. 7. These are:

getAdministrationZoneName( ) returns the name of the zone, getSubordinateZones( ) returns the WSDLs for subordinate administration zones, and

getResourceModelNames( ) returns the names of the resource models within the zone, starting with the primary resource model,

getAssetInventory( ) returns information about the asset that owns a resource model,

getUpdatePolicy( ) returns the update policy of the asset,

getBespokeAdminInterface( ) returns the web service interface for an asset that has an update policy of BESPOKE_UPDATE,

getResourceTypes( ) returns information about the resourcetypes in the resource model,

getResourceEntryIds( ) returns a list of all resource entry ids for a resource type, getResourceEntries( ) returns a list of resource entries.

The firstindex and lastindex parameters can be used to control the number of entries returned. (If there are fewer entries for the resource type than requested by the index parameters, the service returns as many as are available), createResourceEntry( ) is used to add a new resource entry to a resource type, getResourceEntry( ) returns a single resource entry, updateResourceEntry( ) replaces the resourceEntryValue in the resource entry with the new value supplied on the operation, and

deleteResourceEntry( ) removes the resource entry from the configuration data.

FIGS. 4 to 7 describe the administration architecture of the data processing system. This architecture ensures a solution built from the assets 12 can be administered from a single point of control. This is achieved by partitioning the management of configuration data between the solution 10 and some of the assets 12a within the system.

The structure of administration ensures that a solution built from assets can be configured and managed from a single point of control. Assets are plug-and-play so each deployment of a system could involve a different implementation of a particular service. Since each implementation of a service is likely to need different configuration data, administration must also be plug-and-play.

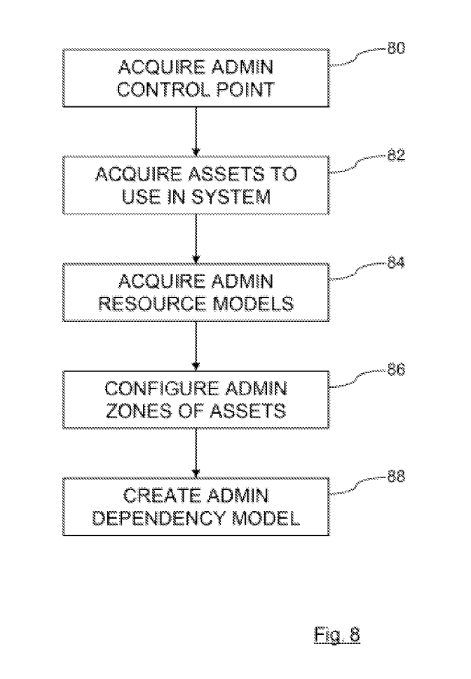

FIG. 8 illustrates a method of constructing the data processing system, which comprises acquiring (step 80) the administration control point 18 and acquiring (step 82) the plurality of independent assets 12a and dependent assets 12b. Once the assets 12 to be used in the system are determined and selected, then the next action is the acquiring (step 84) of a plurality of administration resource models 22, each of which defines the configuration data required by the respective asset. The next step 86 is the configuring of the administration zones 20 of the independent assets 12a such that each zone 20 comprises a link to the administration resource model 22 for that independent asset 12a and each administration resource model 22 for a dependent asset 12b has a link present in an administration zone 20. Every admin zone 22 will have at least one link to a model 22 for that asset 12a and may have one or more links to model(s) 22 for other dependent assets. The method also includes creating (step 88) an administration dependency model 24, which defines the hierarchy of the independent assets 12a and dependent assets 12b.

In the drawings and specifications there has been set forth a preferred embodiment of the invention and, although specific terms are used, the description thus given uses terminology in a generic and descriptive sense only and not for purposes of limitation.

1. Apparatus comprising:
an administration control point,
a plurality of independent assets and dependent assets, each independent asset including an administration zone connected to the administration control point, and
a plurality of administration resource models each defining configuration data required by a respective asset,
each administration zone having a link to the administration resource model for the respective independent asset and each administration resource model for a dependent asset having a link present in an administration zone.

2. Apparatus according to claim 1, and further comprising an administration dependency model defining the hierarchy of independent assets and dependent assets.

3. Apparatus according to claim 1, and further comprising a database storing configuration data.

4. Apparatus according to claim 1, wherein the administration control point includes a service interface.

5. Apparatus according to claim 4, and further comprising a graphical user interface connected to the service interface of the administration control point.

6. Apparatus according to claim 2 further comprising a database storing configuration data and wherein the administration control point includes a service interface.

7. Apparatus according to claim 6 and further comprising a graphical user interface connected to the service interface of the administration control point.

8. Method comprising:
acquiring an administration control point and a plurality of independent assets and dependent assets, each independent asset including an administration zone connected to the administration control point,
acquiring a plurality of administration resource models each defining configuration data required by a respective asset, and
configuring the administration zones such that each comprises a link to the administration resource model for the respective independent asset and each administration resource model for a dependent asset has a link present in an administration zone.

9. Method according to claim 8, and further comprising creating an administration dependency model defining the hierarchy of independent assets and dependent assets.

10. Method according to claim 8, and further comprising acquiring a database and storing configuration data in said database.

11. Method according to claim 8, wherein the administration control point includes a service interface.

12. Method according to claim 11, and further comprising acquiring a graphical user interface and connecting said graphical user interface to the service interface of the administration control point.

13. Method according to claim 9 and further comprising acquiring a database and storing configuration data in said database and further wherein the administration control point includes a service interface.

14. Method according to claim 13 and further comprising acquiring a graphical user interface and connecting said graphical user interface to the service interface of the administration control point.

15. A computer program product on a computer readable medium for constructing a data processing system, the product comprising instructions for acquiring an administration control point and a plurality of independent assets and dependent assets, each independent asset including an administration zone connected to the administration control point, for acquiring a plurality of administration resource models each defining configuration data required by a respective asset, and for configuring the administration zones such that each comprises a link to the administration resource model for that independent asset and each administration resource model for a dependent asset has a link present in an administration zone.

16. A computer program product according to claim 15, and further comprising instructions for creating an administration dependency model defining the hierarchy of independent assets and dependent assets.

17. A computer program product according to claim 15, and further comprising instructions for acquiring a database and for storing configuration data in said database.

18. A computer program product according to claim 15, wherein the administration control point includes a service interface.

19. A computer program product according to claim 18, and further comprising instructions for acquiring a graphical user interface and for connecting said graphical user interface to the service interface of the administration control point.

20. A computer program product according to claim 16 and further comprising instructions for acquiring a database and for storing configuration data in said database and wherein the administration control point includes a service interface.
